(19) United States
(12) Patent Application Publication
(10) Pub. No.: US 2026/0304477 A1
(43) Pub. Date: Oct. 1, 2026

(54) SIMPLE MULTI-AP TXOP SHARING

(71) Applicant: Telefonaktiebolaget LM Ericsson (publ), Stockholm (SE)

(72) Inventors: Charlie PETTERSSON, Solna (SE); Dennis SUNDMAN, Sollentuna (SE); Abhishek AMBEDE, Huddinge (SE); Rocco DI TARANTO, Lund (SE)

(21) Appl. No.: 19/477,976

(22) PCT Filed: May 8, 2024
(86) PCT No.: PCT/EP2024/062789

§ 371 Date: Oct. 23, 2025

Related U.S. Application Data
(60) Provisional application No. 63/501,287, filed on May 10, 2023.

(51) Int. Cl. H04W 74/0816; H04W 74/0833; H04W 84/12

(52) U.S. Cl. CPC H04W 74/0816; H04W 74/0833; H04W 84/12

(57) ABSTRACT

Methods and apparatuses are disclosed. A method of a first access point (AP) in a wireless local area network (WLAN), which first AP has reserved a transmit opportunity (TXOP) for sharing at least some resources of the TXOP with one or more other APs is described. The method includes transmitting an invitation signal to at least one of the other APs, wherein the invitation signal includes an indication on sharable TXOP resources and an indication that the resources should be contended for using a random access (RA) procedure.

### TECHNICAL FIELD

The present invention generally relates to transmit opportunity sharing between access points in a wireless communication system such as a wireless local area network.

### BACKGROUND

Random access (RA) schemes dynamically assign radio resources to a large set of users, each with likely bursty traffic. A wide variety of solutions have been proposed to solve the problem of how to efficiently allow many terminals to transmit their randomly arriving messages.

RA procedures have been defined and used for different scenarios in a communication system specified under IEEE 802.11 wireless local area network (WLAN) standard, “IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications,” in IEEE Std 802.11-2020 (Revision of IEEE Std 802.11-2016), pp. 1-4379, 26 Feb. 2021. hereafter referred to IEEE 802.11 in short. Most commonly known, a carrier sense multiple access with collision avoidance (CSMA/CA) scheme is the main way IEEE 802.11 WLANs resolve channel access contention when the medium is idle. Essentially a device that wants to access the medium after it becomes available must draw a random number indicating how many backoff slots the device needs to find the medium idle before it is allowed to initiate its transmission. Furthermore, a contention window is used to limit the available numbers to draw from. This contention window then increases when collisions occur, making further collisions less likely.

In IEEE 802.11ax-2021 (IEEE Standard for Information Technology—Telecommunications and Information Exchange between Systems Local and Metropolitan Area Networks—Specific Requirements, Part 11: Wireless LAN Medium Access Control (MAC) and Physical Layer (PHY) Specifications, Amendment 1: Enhancements for High-Efficiency WLAN), also termed as ‘High Efficiency (HE)’ amendment, subclause 26.5.4.1, an uplink (UL) orthogonal frequency division multiple access (OFDMA) random access procedure (UORA) is described. In the UORA mechanism, multiple (not triggered by an access point (AP) and therefore without pre-assigned resources for their UL transmission) non-AP stations (STAs) can transmit data frames at the same time on different resource units (RUs), specifically allocated by the AP for the UORA operation. To transmit a frame, each STA selects a random backoff counter within the contention window value and decreases it by the number of RUs available for UORA. If the decreased counter becomes less than or equal to zero, the STA is allowed to transmit the frame with an arbitrarily available RU.

For addressing devices in IEEE 802.11, a medium access control (MAC) sublayer address is used and is one of the following two types:
1. Individual address: The address assigned to a particular STA on the network.
2. Group address: A multi-destination address, which might be in use by one or more STAs on a given network.

The two kinds of group addresses are as follows:
a. Multicast-group address: An address associated by higher level convention with a group of logically related (non-AP) STAs.
b. Broadcast address: A distinguished, predefined group address that always denotes the set of all STAs on a given local area network (LAN), i.e., both AP STAs as well as non-AP STAs. This group is predefined for each communication medium to consist of all STAs actively connected to that medium; it is used to broadcast to all the active STAs on that medium.

Introduced in IEEE 802.11ah amendment, a group association identifier (AID) is an association identifier (AID) that is assigned by an AP to identify a group of STAs. A STA may request a group AID from the AP to which it is associated to by sending an AID Switch Request frame. A short inter-frame space (SIFS) interval after receiving the AID Switch Request frame, the AP responds with an AID Switch Response frame that contains the assigned group AID that corresponds to that group address and the group listen interval.

It can be noted that a group AID is only used to address a group of non-AP STAs.

There is currently no provision in IEEE 802.11 to assign a group address to a group of AP STAs.

Transmit opportunity (TXOP) is a MAC layer feature used in IEEE 802.11-based wireless local area network (WLAN). TXOP defines the time duration for which a station can send frames after it has won the contention. By providing this contention-free time period, TXOP aims to increase the throughput of high priority data, such as voice and video.

In IEEE 802.11be amendment, also denoted as ‘Extremely High Throughput (EHT)’ amendment, that is currently under development, multi user (MU) ready to send (RTS) TXOP sharing (MU-RTS TXS) has been introduced, which may be used by an AP to give away some time/frequency resources, within its reserved TXOP, to one other non-AP STA. The two use cases that are targeted are triggered channel access for peer-to-peer communication between non-AP STAs, and triggered single user UL transmissions.

After a non-AP EHT STA receives an MU-RTS TXS Trigger frame from its associated AP that contains a User Info field that is addressed to it, the STA may transmit one or more non-TB PPDUs within the time allocation signalled in the MU-RTS TXS Trigger frame. The first PPDU of the exchange shall carry a CTS frame.

FIG. 1, which corresponds to what is shown in draft IEEE specification P802.11be D3.0 (FIG. 35-2 therein), illustrates an example of MU-RTS TXS Trigger frame with triggered TXOP sharing mode subfield value equal to 2. An MU-RTS Trigger frame (introduced in IEEE 802.11ax amendment) that has the Triggered TXOP Sharing Mode subfield set to a nonzero value is called an MU-RTS TXS Trigger frame. The Triggered TXOP Sharing Mode subfield in the Common Info field is set to a nonzero value if the MU-RTS Trigger frame is sent by an EHT AP that intends to allocate time within an obtained TXOP to an associated non-AP EHT STA for transmitting one or more non-TB PPDUs sequentially otherwise it is set to 0. The encoding of the Triggered TXOP Sharing Mode subfield is illustrated in FIG. 2, which also corresponds to what is shown in draft IEEE specification P802.11be D3.0 (Table 9-53c therein).

The HE and EHT variants of the User Info field for MU-RTS TXS Trigger frame are illustrated in FIGS. 3 and 4, which also corresponds to what is shown in draft IEEE specification P802.11be D3.0 (FIGS. 9-95a and 9-95b therein). The AID12 subfield is equal to the 12 least significant bits (LSBs) of the association identifier (AID) of the non-AP STA which is the intended recipient of the MU-RTS TXS trigger frame. The Allocation Duration subfield in the User Info field of the MU-RTS TXS Trigger frame indicates the time duration allocated to the non-AP STA within the TXOP obtained by the AP, in units of 16 μs.

Multi-AP, i.e., coordination among APs to share reserved time/frequency/spatial resources, was a key candidate feature for EHT, but because of time constraints due to the complexity of multi-link operation, another feature already introduced in EHT, it was later dropped from the scope completely. There were many different Multi-AP schemes, that require different complexity. Some of the proposed schemes were: C-TDMA (Coordinated TDMA, Time Domain Multiple Access), C-OFDMA (Coordinated OFDMA, Orthogonal Frequency Division Multiple Access), C-SR (Coordinated Spatial Reuse), C-BF (Coordinated Beamforming). In these schemes, the fundamental idea is that an AP obtaining a (time-frequency) transmit opportunity, TXOP, termed a sharing AP, may share its TXOP with other APs, termed shared APs, in different manners.

In Ultra-High Reliability Study Group (UHR SG) it is proposed to reuse the MU-RTS TXS for TXOP sharing framework already available in EHT amendment to also support some multi-AP coordination. In IEEE contributions IEEE 802.11.23/0041r0 with title “Considerations on Coordinated TDMA (C-TDMA)” and IEEE 802.11-23/261r0 with title “C-TDMA procedure in UHR” it has been proposed that multi-AP coordination is kept very simple and thus sharing a TXOP with only one other AP at a time should be considered, that is, one ‘sharing AP’ can only give away resources to only one other neighbour ‘shared AP’ from its ‘AP candidate set’, that is its set of available potential shared APs. The one other shared AP can be addressed by reusing the addressing field already defined in the MU-RTS TXS Trigger frame. However, these IEEE contributions do not discuss how a sharing AP should select the specific one other shared AP.

Thus, for a sharing AP to share a TXOP requires a communication protocol with message exchanges with some, or all APs, in an AP candidate set. Assuming the sharing AP will only allow a small number of shared AP for the TXOP, this may cause a significant overhead. Alternatively, the sharing AP has to make a guess for what shared AP to choose from its AP candidate set without knowing anything about its current conditions or the conditions in that respective BSS, such as buffer status. It is therefore a desire to at least alleviate these drawbacks.

The above information disclosed in this Background section is only for enhancement of understanding of the background of the invention and therefore it may contain information that does not form the prior art that is already known to a person of ordinary skill in the art.

### SUMMARY

Aspects are provided in the independent claims, and embodiments thereof are provided in the dependent claims.

The invention is based on the inventors' realization that it would be beneficial for a sharing AP to share its TXOP with one or more other shared APs, without the sharing AP needing to obtain any specific information or message exchanges from the AP candidate set.

The TXOP owner invites other APs to use the TXOP resources by means of a RA procedure. The sharing AP may constrain the TXOP sharing based on, for example, traffic characteristics or type of communication. By doing so, APs with, e.g., critical traffic, may be prioritized in the RA procedure.

### BRIEF DESCRIPTION OF THE DRAWINGS

The above, as well as additional objects, features, and advantages of the present invention, will be better understood through the following illustrative and non-limiting detailed description of preferred embodiments of the present invention, with reference to the appended drawings.

FIG. 1 shows an example of MU-RTS TXS Trigger frame.

FIG. 2 illustrates encoding of the Triggered TXOP Sharing Mode subfield.

FIGS. 3 and 4 illustrate variants of User Info field for MU-RTS TXS Trigger frame for HE and EHT.

FIGS. 5 to 8 illustrate RA by a set of multiple invited APs in C-TDMA scheme.

FIGS. 9 and 10 show slightly different operations when the invitation is sent at the beginning of the TXOP.

FIG. 11 illustrates C-OFDMA with simple Multi-AP TXOP sharing scheme.

FIG. 12 is a flow chart illustrating a method according to an embodiment.

FIG. 13 is a flow chart illustrating a method according to an embodiment.

FIG. 14 is a block diagram schematically illustrating an AP according to an embodiment.

FIG. 15 schematically illustrates a computer-readable medium and a processing device.

### DETAILED DESCRIPTION

It is proposed in this disclosure that a sharing AP that has reserved a TXOP and has decided that it wants to give away at least some specific time/frequency/spatial resources of the TXOP, termed ‘shared TXOP resources’, to more than one other APs, termed ‘invited APs’. Throughout this description, the RA procedure is given as examples with the CSMA/CA-like LBT using backoff (BO) counters. Other RA procedures are possible and can be specifically designed.
The BO counter used may or may not be the same BO counter as for when the AP is contending for channel access independently by itself. If it is the same BO counter, the invited APs that participate in the shared TXOP must restore the BO counter value to that before receiving invitation from the sharing AP. This is to maintain fairness across all APs, invited and non-invited.
An independent BO counter for this particular purpose may be used.

However, any other RA channel mechanisms may be used.

The overall procedure of the invention can be simplified into the steps of,
a) The sharing AP transmits an invitation signal to the invited APs indicating that they have an opportunity to use the shared TXOP resources,
b) The invited APs contend for using the shared TXOP resources through RA.
c) The one or more shared APs use the shared TXOP resources for orchestrating wireless communications in their one or more respective BSSs.

The suggestion is exemplified using C-TDMA below, and it is briefly explained how it works for C-OFDMA further below. However, the suggestion is applicable also to other C-AP schemes.

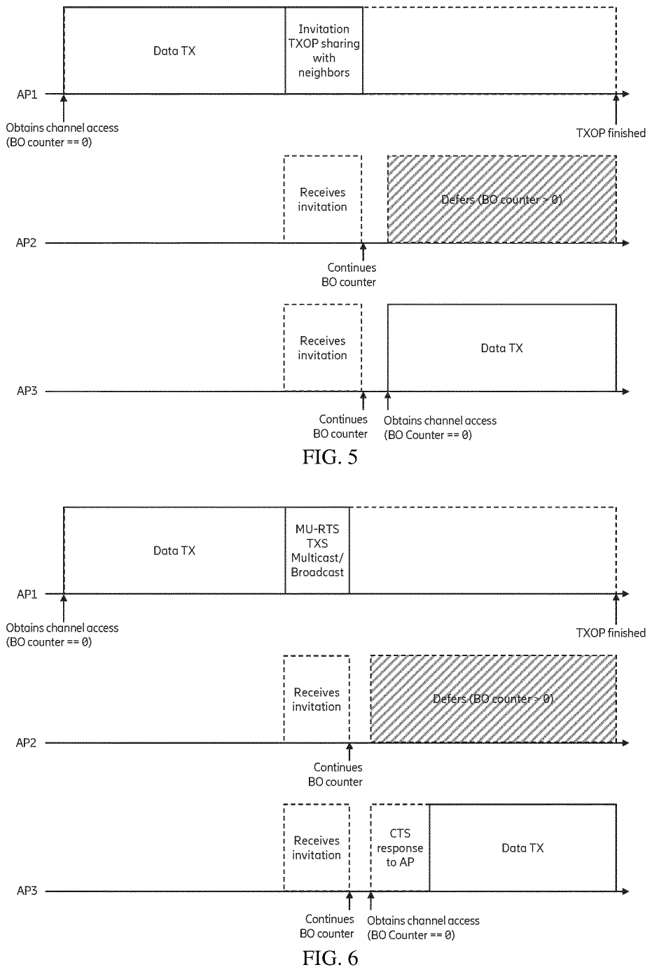

FIGS. 5 to 8 illustrate RA by a set of multiple invited APs in C-TDMA scheme. In FIG. 5, one method is shown. Here, AP1 has won the TXOP and decides at some point to share the TXOP with a set of other neighbour APs including AP2 and AP3 which are together termed as invited APs.

AP1 sends an invite to share the TXOP, which notifies AP2 and AP3 to continue (or start) their BO counter. The BO counter may be continuation of the normal CSMA/CA BO counter, or it may be a separate BO counter used only for TXOP sharing purposes. The AP first reaching 0 becomes the shared AP—in this example, it is shown that only one AP wins the contention and reaches 0 (this is most likely scenario especially when the traffic load is low in the different invited AP's BSSs). However, if more than one invited APs win the contention and use the shared TXOP resources without interfering with each other's operations in a significant manner, then the proposed solution also allows for better overall performance—as the solution does not limit the sharing to be done with only one specific other AP. When multiple invited APs simultaneously transmit using the shared TXOP resources, collisions may happen due to hidden node problem (e.g., if two APs cannot hear each other but their respective associated STAs can hear both APs, hidden node problems may arise during downlink reception at a STA due to transmissions from the other AP)—however, such hidden node related issues can be resolved or minimized using already existing mechanisms such as request-to-send (RTS)/clear-to-send (CTS) frame exchanges prior to the corresponding data communications or by constraining the invited APs' participation in a suitable manner (e.g., by mandating the invited APs to use a suitably reduced transmit power), or by the sharing AP inviting sets of potential shared AP that are all in range of each other. If nobody joins the TXOP sharing, the sharing AP may release the TXOP using for example the CF-End (contention free end) frame.

FIG. 6 illustrates how an embodiment can be realized using the MU-RTS TXS Trigger frame by addressing it to multiple APs—either in a broadcast fashion or in multicast fashion. In a related embodiment, it is proposed that the Triggered TXOP Sharing Mode subfield value in the MU-RTS TXS Trigger frame is set to 3, which is currently a reserved value in the EHT spec (in draft IEEE specification P802.11be D3.0). The Shared AP (AP3) first obtaining channel access, sends a CTS response to the AP and may then continue with the Data TX. Note that if two invited APs send the CTS response to the AP at the same time instance, they may collide and the shared TXOP may be interfered. However, the collision of the CTS frames may not be a concern since it may only result in the sharing AP not being able to read the CTS frame to know which specific invited AP won the contention. However, the sharing AP may be able to detect the subsequent frames and do this identification successfully in any case—from the perspective of the sharing AP, the only key point of receiving the CTS successfully is to know that its shared resources are going to be used.

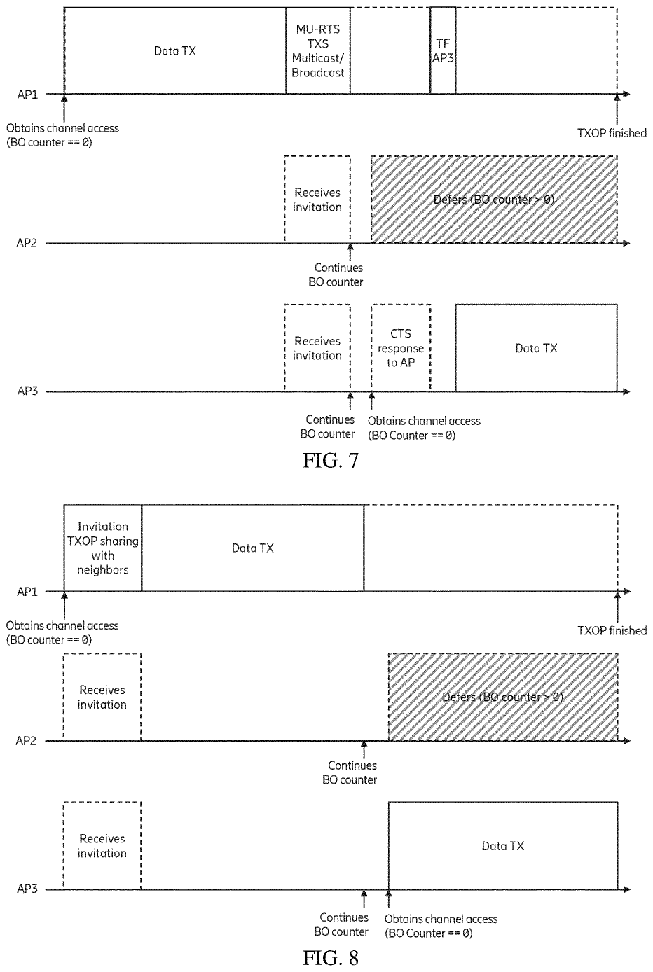

FIG. 7 illustrates an embodiment where the AP sends a trigger frame (TF) to the winner(s) of the contention. As discussed earlier, this method of distributing the access helps when there is a risk of collision for the “CTS response to AP” message between several APs. A drawback with this embodiment compared with the previous embodiment is that it poses additional overhead. Furthermore, it may unnecessarily limit the number of shared APs participating. FIG. 8 illustrates a variant of the previous embodiment, where the invitation is sent in the beginning of the TXOP rather than later.

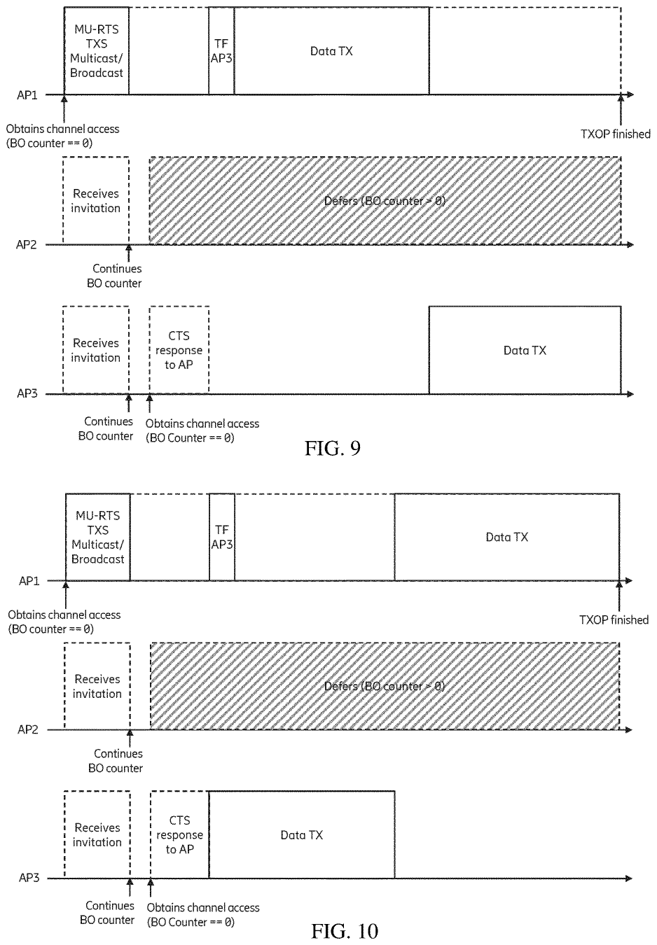

FIGS. 9 and 10 show slightly different operations when the invitation is sent at the beginning of the TXOP. FIG. 9 illustrates a variant where the invitation is sent in the beginning of the TXOP, and the contention is resolved immediately. FIG. 10 illustrates a variant where the invitation is sent in the beginning of the TXOP, where the contention is resolved, and resources are given away immediately.

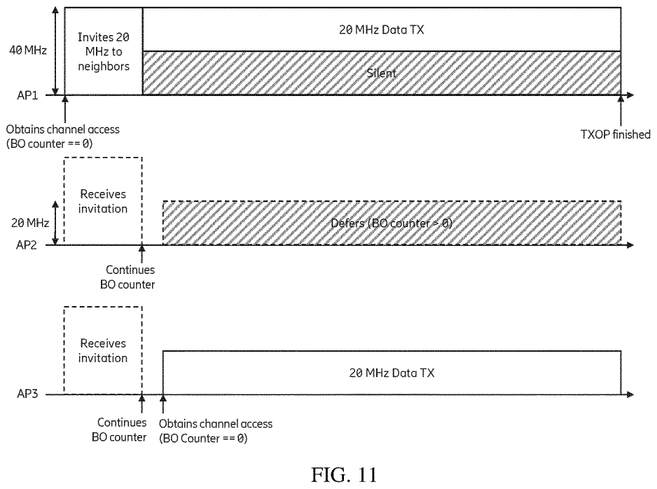

FIG. 11 illustrates C-OFDMA with simple Multi-AP TXOP sharing scheme. It works very similar to C-TDMA, but in this example there is a 40 MHz channel, and the sharing AP only shares 20 MHz of that. The core is still to use a RA method as described in previous sections to lift the burden of signalling overhead from the sharing AP. This embodiment resembles Uplink OFDMA Random Access (UORA), and similar mechanisms may be used.

In an embodiment, it is proposed that the invited APs are a group of ‘specific’ other APs in the vicinity of the sharing AP that is selected by the sharing AP and addressed using a specific common group address included in an address field in the invitation signal. In a related sub-embodiment, it is proposed that the specific common group address is shared by the sharing AP with the invited APs before the TXOP sharing occurs, either in a solicited manner (i.e., upon request to do so by another AP) or an unsolicited manner (i.e., without being requested to do so by another AP).

In an alternative embodiment, it is proposed that the invited APs include all of the APs in the vicinity of the sharing AP that are addressed using an AP-specific broadcast address included in an address field in the invitation signal.

In an alternative embodiment, it is proposed that the invited APs include the APs in the vicinity of the sharing AP and that are all in range of each other. They may also be addressed using an AP-specific broadcast or group address included in an address field in the invitation signal.

In another embodiment, it is proposed that the addressing of the invited APs is performed by reusing the AID12 field in the User Info field if the MU-RTS TXS Trigger frame is used to send the invitation signal.

Note that in the above embodiments, the proposed group addressing features a key aspect of only addressing multiple APs in both cases—the specific common group address as well as the AP-specific broadcast address, and not addressing any non-APs.

Below are some features described as embodiments, but the skilled reader will from its context understand that the features of these embodiments are such that they are readily combined with the embodiments demonstrated above, and also with each other.

In an embodiment, it is proposed that the TXOP sharing performed by the sharing AP contains limitations on who may contend for the shared resources, by means of including information about such constraints in the inviting signal.

In a related embodiment, it is proposed that the limitations are based on traffic characteristics of the data that is to be communicated, for example based on Access Categories (AC) or traffic identifiers (TID).

In another related embodiment, it is proposed that the limitations are based on the type of communication that can be undertaken by the shared APs—downlink (i.e., AP to non-AP), uplink (i.e., non-AP to AP), peer-to-peer (i.e., non-AP to AP), AP-to-AP.

In another embodiment of the invention, the address that is used as the transmitter address when the TXOP reservation happens is either the individual address of the sharing AP or the group address of the invited APs. Depending on what address is used additional rules and signalling may be needed to make sure that the potentially invited APs stay awake and listens to the TXOP sharing message.

In yet another embodiment, depending on what option is used to reserve the TXOP by the sharing AP, it may start the contention period either by means of explicit signalling (such as a trigger frame) or implicitly (when the medium becomes idle). For example, using the group address already at the beginning of the TXOP may save additional signalling overhead by informing the invited APs already then how to contend for the shared TXOP resources.

The suggested approach may be used recursively, for example an AP that gets 50% of a TXOP from a sharing AP may only need 25% of its TXOP and can therefore further share the remaining 25% with its AP candidate set.

In an additional frequency-dimension related embodiment, it is proposed that the sharing AP divides the TXOP resources in frequency and invites different non-identical sets of APs to perform RA contention for the different frequency portions. As an example—invited APs may have different primary 20 MHz channels, the sharing AP can set a restriction that only each AP's primary 20 MHz channels should be used by the contending APs. This procedure can also be done in time, having a subset of APs contending for a first time period and another subset in a different time period. In other words, this constitutes some sort of semi-scheduled RA procedure. If there are many APs that want to share the medium, this embodiment can help to share the resources more evenly. However, if there are only few APs that want to share the medium, resources may be left unused.

A method is here given as an example for a sharing AP to share its TXOP with one, or more APs in an efficient and simplistic manner. The method is presented for all participating entities, i.e., APs, but each entity will naturally perform their respective methods. An aggregate method, for the easier understanding of the concept, can in general be considered to comprise:

1. A sharing AP that has reserved a TXOP and has decided that it wants to give away at least some specific time/frequency/spatial resources of the TXOP, termed shared TXOP resources, to more than one other invited APs,
a. Transmits an invitation signal to the invited APs indicating that they have an opportunity to use the shared TXOP resources,
b. The invited APs contend for using the shared TXOP resources through a RA mechanism,
c. One or more out of the invited APs which wins contention becomes the one or more shared APs for this TXOP,
d. The one or more shared APs use the shared TXOP resources for orchestrating wireless communications in their one or more respective BSSs.

2. As in 1, where the invited APs is a subset of neighbouring APs in the vicinity of the sharing AP that is selected by the sharing AP and addressed using a specific common group address included in an address field in the invitation signal.

3. As in 2, where the specific common group address is shared by the sharing AP with the invited APs before the TXOP sharing occurs, either in a solicited manner (i.e., upon request to do so by another AP) or an unsolicited manner (i.e., without being requested to do so by another AP).

4. As in 1, wherein the invited APs includes all the APs in the vicinity of the sharing AP (or all the APs in the vicinity of the sharing AP that are in range of each other) that are addressed using an AP-specific broadcast address included in an address field in the invitation signal.

5. As in any of the above, where the RA mechanism is performed by the invited APs only during the shared TXOP, and does not affect the invited APs' channel access outside the shared TXOP.

6. As in any of the above, where the TXOP sharing performed by the sharing AP contains limitations on who may contend for the shared resources.

7. As in 6, where the limitations are based on traffic characteristics of the data that is to be communicated, for example based on Access Categories (AC) or traffic identifiers (TID).

8. As in 6 or 7, where the limitations are based on the type of communication that can be undertaken by the shared APs—downlink (i.e., AP to non-AP), uplink (i.e., non-AP to AP), peer-to-peer (i.e., non-AP to AP), AP-to-AP.

9. As in any of the above, where the invitation signal is a variant of the MU-RTS TXS Trigger frame.

10. As in 9, where the Triggered TXOP Sharing Mode subfield value in the MU-RTS TXS Trigger frame is set to 3.

11. As in 9 or 10, wherein the addressing of the invited APs is performed by reusing the AID12 field in the User Info field of the MU-RTS TXS Trigger frame.

12. As in any of the above, where the TXOP is reserved by the address of the sharing AP.

13. As in any of the above, where the TXOP is reserved by the group address of the invited APs.

14. As in any of the above, where the start of the contention period is either explicitly signalled (for example by a trigger frame) or implicitly started (for example when the medium becomes idle)

15. As in 14, where the selection of the two options may be based upon the address that has reserved the TXOP.

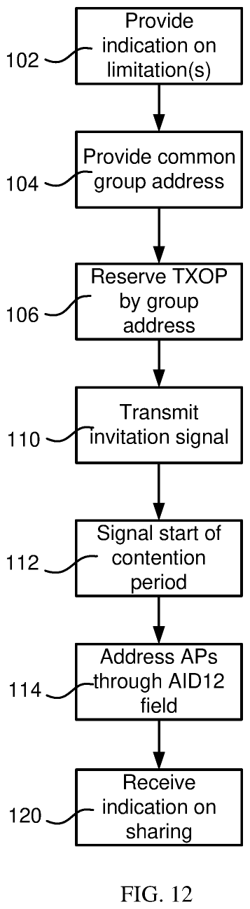

The respective methods as mentioned above will comprise subsets of the actions as demonstrated above. FIG. 12 is a flow chart illustrating methods performed by a sharing AP, i.e., the AP that has reserved a transmit opportunity (TXOP) and will share at least some resources of the TXOP with one or more other APs., the method comprises transmitting 110 an invitation signal to at least one of the other APs. The invitation signal comprises an indication on sharable TXOP resources. The method further comprises receiving 120 an indication from one of the at least one of the other APs that the TXOP is shared.

The indication may comprise a clear to send (CTS) response and/or a data transmission. The sharing AP will then know that the resources offered for sharing are used by one or more of the other APs.

The method may comprise providing 102 an indication on limitation on contending for the sharable TXOP resources. The method may comprise providing 104 a common group address before the TXOP occurs. The method may comprise reserving 106 the TXOP by the group address. The limitation on contending may for example comprise any one or more of:
which AP(s) that belongs to the one or more other APs;
limitation based on traffic characteristics of data to be communicated by the at least one of the another APs;
limitation based on Access Categories (AC) of data to be communicated by the at least one of the another APs;
limitation based on traffic identifiers (TID) of data to be communicated by the at least one of the another APs; and
limitations based on type of communication to be used by the at least one of the another APs.

The invitation signal can beneficially be a type of multi-user ready to send transmit opportunity sharing (MU-RTS TXS) Trigger frame. A subfield of the MU-RTS TXS Trigger frame can for example be a Triggered TXOP Sharing Mode subfield set to 3. The method may comprise signalling 112 a start of a contention period. Alternatively, without specific signalling, a contention period can be assigned to start after a used medium becomes idle after the transmission including the invitation signal. The method may comprise addressing 114 the one or more other APs, wherein the addressing is performed through AID12 field in a User Info field of the MU-RTS TXS Trigger frame.

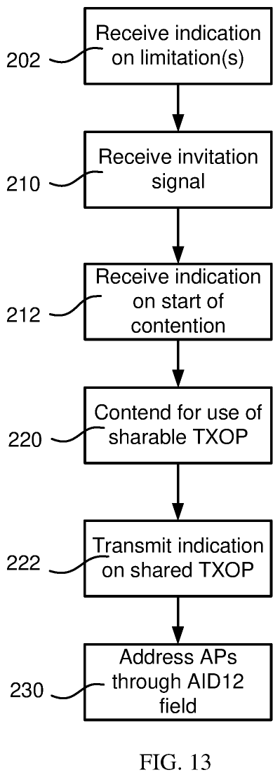

FIG. 13 is a flow chart illustrating a method of a second access point (AP) in a wireless local area network (WLAN) for sharing at least some resources of a TXOP with at least a first AP, which first AP has reserved a transmit opportunity (TXOP) and provided an invitation signal. The method comprises receiving 210 the invitation signal, wherein the invitation signal comprises an indication on sharable TXOP resources. The method further comprises contending 220 for using the sharable TXOP resources through a RA mechanism. The method also comprises orchestrating 230, when the contended TXOP resources are won, wireless communication with shared TXOP resources in a basic service set (BSS) associated with the second AP.

The invitation signal may comprise an indication addressing the second AP. The invitation signal may address the second AP through a group address included in an address field of the invitation signal.

The method may comprise receiving 202 an indication on limitation on contending for the sharable TXOP resources. The limitation on contending may comprise any one or more of:
which AP(s) that belongs to invited APs;
limitation based on traffic characteristics of data to be communicated by the invited APs;
limitation based on Access Categories (AC) of data to be communicated by the invited APs;
limitation based on traffic identifiers (TID) of data to be communicated by the invited APs; and
limitations based on type of communication to be used by the invited APs.

The invitation signal may be a type of multi-user ready to send transmit opportunity sharing (MU-RTS TXS) Trigger frame. A subfield of the MU-RTS TXS Trigger frame may be a Triggered TXOP Sharing Mode subfield set to 3.

The method may comprise receiving 212 an indication on a start of a contention period. Alternatively or additionally, a contention period is assumed to start after a used medium becomes idle after the transmission including the invitation signal.

The method may comprise transmitting 222, when the contended TXOP resources are won, an indication from one of the at least one of the other APs that the TXOP is shared. The indication may comprise a clear to send (CTS) response and/or a data transmission.

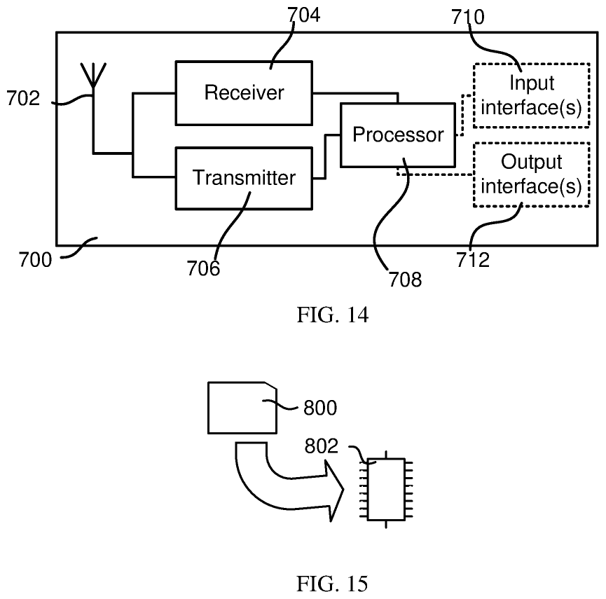

FIG. 14 is a block diagram schematically illustrating an AP 700 according to an embodiment. The AP 700 comprises an antenna arrangement 702, a receiver 704 connected to the antenna arrangement 702, a transmitter 706 connected to the antenna arrangement 702, a processing element 708 which may comprise one or more circuits, one or more input interfaces 710 and one or more output interfaces 712. The interfaces 710, 712 can be user interfaces and/or signal interfaces, e.g., electrical or optical. The AP 700 is arranged to operate in a wireless communication network such as a wireless local area network. In particular, by the processing element 708 being arranged to perform the embodiments demonstrated with reference to FIGS. 5 to 13, the AP 700 is capable of sharing TXOP resources through offering sharing to other APs and/or accepting an invite to share from another AP. The processing element 708 can also fulfil a multitude of tasks, ranging from signal processing to enable reception and transmission since it is connected to the receiver 704 and transmitter 706, executing applications, controlling the interfaces 710, 712, etc.

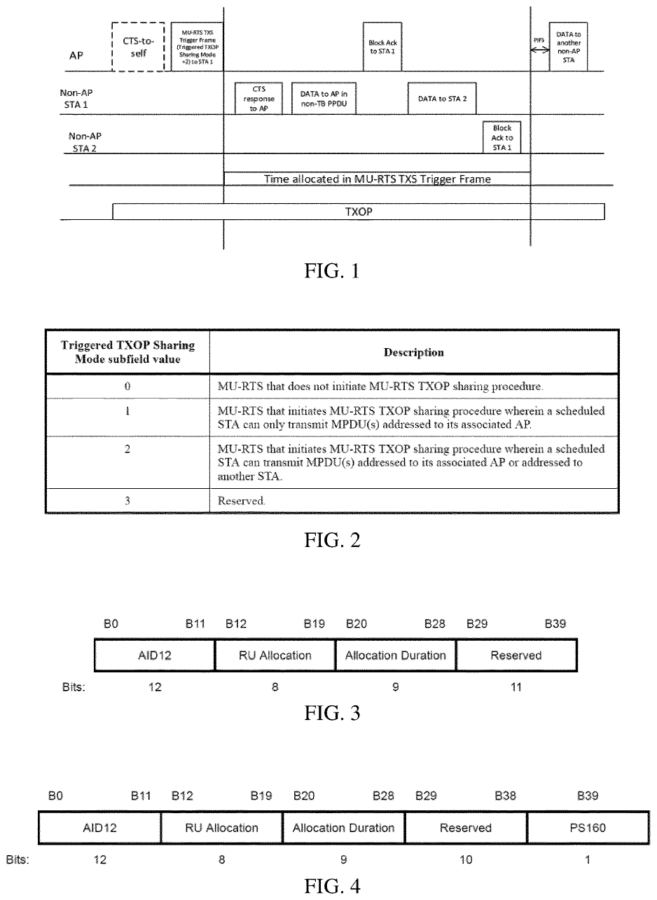

The methods according to the present invention is suitable for implementation with aid of processing means, such as computers and/or processors, especially for the case where the processing element 708 demonstrated above comprises a processor handling TXOP sharing. Therefore, there is provided computer programs, comprising instructions arranged to cause the processing means, processor, or computer to perform the steps of any of the methods according to any of the embodiments described with reference to FIG. 1 to 6. The computer programs preferably comprise program code which is stored on a computer readable medium 800, as illustrated in FIG. 15, which can be loaded and executed by a processing means, processor, or computer 802 to cause it to perform the methods, respectively, according to embodiments of the present invention, preferably as any of the embodiments described with reference to FIGS. 5 to 13. The computer 802 and computer program product 800 can be arranged to execute the program code sequentially where actions of the any of the methods are performed stepwise, or be performed on a real-time basis. The processing means, processor, or computer 802 is preferably what normally is referred to as an embedded system. Thus, the depicted computer readable medium 800 and computer 802 in FIG. 15 should be construed to be for illustrative purposes only to provide understanding of the principle, and not to be construed as any direct illustration of the elements.

The disclosed concept can be summarized through the following example embodiments and sub-embodiments:

1. A method of a first access point (AP) in a wireless local area network (WLAN), which first AP has reserved a transmit opportunity (TXOP) for sharing at least some resources of the TXOP with one or more other APs, the method comprising:
transmitting (110) an invitation signal to at least one of the other APs, wherein the invitation signal comprises an indication on sharable TXOP resources and an indication that the resources should be contended for using a RA procedure.

2. The method of embodiment 1, comprising receiving (120) an indication from one or more of the at least one of the other APs that the TXOP is shared in response to the invitation signal.

3. The method of embodiment 2, wherein the indication that the TXOP is shared comprises a clear to send (CTS) response.

4. The method of embodiment 2 or 3, wherein the indication that the TXOP is shared comprises a data transmission.

5. The method of any one of embodiments 1 to 4, comprising providing (104) a common group address before the TXOP occurs.

6. The method of embodiment 5, comprising reserving (106) the TXOP by the group address.

7. The method of any one of embodiments 1 to 6, comprising providing (102) an indication on limitations on contending for the sharable TXOP resources.

8. The method of embodiment 7, wherein the limitation on contending comprises any one or more of:
which AP(s) that belongs to the one or more other APs;
limitation based on traffic characteristics of data to be communicated by the at least one of the another APs;
limitation based on Access Categories (AC) of data to be communicated by the at least one of the another APs;
limitation based on traffic identifiers (TID) of data to be communicated by the at least one of the another APs; and
limitations based on type of communication to be used by the at least one of the another APs.

9. The method of any one of embodiments 1 to 8, wherein the invitation signal is a type of multi-user ready to send transmit opportunity sharing (MU-RTS TXS) Trigger frame.

10. The method of embodiment 9, wherein a subfield of the MU-RTS TXS Trigger frame is a Triggered TXOP Sharing Mode subfield set to 3.

11. The method of embodiment 9 or 10, comprising addressing (114) the one or more other APs, wherein the addressing is performed through AID12 field in a User Info field of the MU-RTS TXS Trigger frame.

12. The method of any one of embodiments 1 to 11, comprising signalling (112) a start of a contention period.

13. The method of any one of embodiments 1 to 11, wherein a contention period starts after a used medium becomes idle after the transmission including the invitation signal.

14. A method of a second access point (AP) in a wireless local area network (WLAN) for sharing at least some resources of a TXOP with at least a first AP, which first AP has reserved a transmit opportunity (TXOP) and provided an invitation signal, the method comprising:
receiving (210) the invitation signal, wherein the invitation signal comprises an indication on sharable TXOP resources and an indication that the resources should be contended for using a RA procedure;
contending (220) for using the sharable TXOP resources through a random access (RA) mechanism;
orchestrating (230), when the contended TXOP resources are won, wireless communication with shared TXOP resources in a basic service set (BSS) belonging to the second AP.

15. The method of embodiment 14, wherein the invitation signal comprises an indication addressing the second AP.

16. The method of embodiment 15, wherein the invitation signal addresses the second AP through a group address included in an address field of the invitation signal.

17. The method of any one of embodiments 14 to 16, comprising receiving (202) an indication on limitation on contending for the sharable TXOP resources.

18. The method of embodiment 17, wherein the limitation on contending comprises any one or more of:
which AP(s) that belongs to invited APs;
limitation based on traffic characteristics of data to be communicated by the invited APs;
limitation based on Access Categories (AC) of data to be communicated by the invited APs;
limitation based on traffic identifiers (TID) of data to be communicated by the invited APs; and
limitations based on type of communication to be used by the invited APs.

19. The method of any one of embodiments 14 to 18, wherein the invitation signal is a type of multi-user ready to send transmit opportunity sharing (MU-RTS TXS) Trigger frame.

20. The method of embodiment 19, wherein a subfield of the MU-RTS TXS Trigger frame is a Triggered TXOP Sharing Mode subfield set to 3.

21. The method of any one of embodiments 14 to 20, comprising receiving (212) an indication on a start of a contention period.

22. The method of any one of embodiments 14 to 20, wherein a contention period starts after a used medium becomes idle after the transmission including the invitation signal.

23. The method of any one of embodiments 14 to 22, comprising transmitting (222), when the contended TXOP resources are won, an indication that the TXOP is shared.

24. The method of embodiment 23, wherein the indication that the TXOP is shared comprises a clear to send (CTS) response.

25. The method of embodiment 23 or 24, wherein the indication that the TXOP is shared comprises a data transmission.

26. A computer program comprising instructions which, when executed on a processor of an access point (AP) causes the AP to perform the method according to any one of embodiments 1 to 25.

27. An access point (AP) in a wireless local area network (WLAN) for sharing at least some resources of a TXOP with at least another AP, comprising
a transceiver; and
a controller arranged to control operation of the AP, wherein the controller is configured to perform the method according to any one of embodiments 1 to 25.

1. A method of a first access point (AP) in a wireless local area network (WLAN), which first AP has reserved a transmit opportunity (TXOP) for sharing at least some resources of the TXOP with one or more other APs, the method comprising:
transmitting an invitation signal to at least one of the other APs, the invitation signal comprising an indication on sharable TXOP resources and an indication that the resources should be contended for using a random access (RA) procedure.

2.-6. (canceled)

7. The method of claim 1, comprising providing an indication on limitations on contending for the sharable TXOP resources, wherein the limitation on contending comprises any one or more of:
which AP(s) that belongs to the one or more other APs;
limitation based on traffic characteristics of data to be communicated by the at least one of the other APs;
limitation based on Access Categories (AC) of data to be communicated by the at least one of the other APs;
limitation based on traffic identifiers (TID) of data to be communicated by the at least one of the other APs; and
limitations based on type of communication to be used by the at least one of the other APs.

8. (canceled)

9. The method of claim 1, wherein the invitation signal is a type of multi-user ready to send transmit opportunity sharing (MU-RTS TXS) Trigger frame.

10.-11. (canceled)

12. The method of claim 1, comprising signalling a start of a contention period.

13. The method of claim 1, wherein a contention period starts after a used medium becomes idle after the transmission including the invitation signal.

14. A method of a second access point (AP) in a wireless local area network (WLAN) for sharing at least some resources of a transmit opportunity (TXOP) with at least a first AP, which first AP has reserved the TXOP and provided an invitation signal, the method comprising:
receiving the invitation signal, wherein the invitation signal comprises an indication on sharable TXOP resources and an indication that the resources should be contended for using a random access (RA) procedure;
contending for using the sharable TXOP resources through a RA mechanism;
orchestrating, when the contended TXOP resources are won, wireless communication with shared TXOP resources in a basic service set (BSS) belonging to the second AP.

15.-16. (canceled)

17. The method of claim 14, comprising receiving an indication on limitation on contending for the sharable TXOP resources, wherein the limitation on contending comprises any one or more of:
which AP(s) that belongs to invited APs;
limitation based on traffic characteristics of data to be communicated by the invited APs;
limitation based on Access Categories (AC) of data to be communicated by the invited APs;
limitation based on traffic identifiers (TID) of data to be communicated by the invited APs; and
limitations based on type of communication to be used by the invited APs.

18. (canceled)

19. The method of claim 14, wherein the invitation signal is a type of multi-user ready to send transmit opportunity sharing (MU-RTS TXS) Trigger frame.

20. (canceled)

21. The method of claim 14, comprising receiving an indication on a start of a contention period.

22. (canceled)

23. The method of claim 14, comprising transmitting, when the contended TXOP resources are won, an indication that the TXOP is shared.

24.-27. (canceled)

28. A first access point (AP) in a wireless local area network (WLAN) for sharing at least some resources of a transmit opportunity (TXOP) with one or more other APs, the first AP comprising:
a transceiver and a controller arranged to control operation of the first AP, the controller being configured to:
transmit an invitation signal to at least one of the other APs, wherein the invitation signal comprises an indication on sharable TXOP resources and an indication that the resources should be contended for using a random access (RA) procedure.

29.-33. (canceled)

34. The first AP of claim 28, wherein the controller is further configured to provide an indication on limitations on contending for the sharable TXOP resources, wherein the limitation on contending comprises any one or more of:
which AP(s) that belongs to the one or more other APs;
limitation based on traffic characteristics of data to be communicated by the at least one of the other APs;
limitation based on Access Categories (AC) of data to be communicated by the at least one of the other APs;
limitation based on traffic identifiers (TID) of data to be communicated by the at least one of the other APs; and
limitations based on type of communication to be used by the at least one of the other APs.

35. (canceled)

36. The first AP of claim 28, wherein the invitation signal is a type of multi-user ready to send transmit opportunity sharing (MU-RTS TXS) Trigger frame.

37.-38. (canceled)

39. The first AP of claim 28, wherein the controller is further configured to perform signalling a start of a contention period.

40. The first AP of claim 28, wherein a contention period starts after a used medium becomes idle after the transmission including the invitation signal.

41. A second access point (AP) in a wireless local area network (WLAN) for sharing at least some resources of a transmit opportunity (TXOP) with at least a first AP, the second AP comprising:
a transceiver and a controller arranged to control operation of the second AP, the controller being configured to:
receive the invitation signal, wherein the invitation signal comprises an indication on sharable TXOP resources and an indication that the resources should be contended for using a random access (RA) procedure;
contend for using the sharable TXOP resources through a RA mechanism;
orchestrate, when the contended TXOP resources are won, wireless communication with shared TXOP resources in a basic service set (BSS) belonging to the second AP.

42.-43. (canceled)

44. The second AP of claim 41, wherein the controller is further configured to receive an indication on limitation on contending for the sharable TXOP resources, wherein the limitation on contending comprises any one or more of:
which AP(s) that belongs to invited APs;
limitation based on traffic characteristics of data to be communicated by the invited APs;
limitation based on Access Categories (AC) of data to be communicated by the invited APs;
limitation based on traffic identifiers (TID) of data to be communicated by the invited APs; and
limitations based on type of communication to be used by the invited APs.

45. (canceled)

46. The second AP of claim 41, wherein the invitation signal is a type of multi-user ready to send transmit opportunity sharing (MU-RTS TXS) Trigger frame.

47. (canceled)

48. The second AP of claim 41, wherein the controller is further configured to receive an indication on a start of a contention period.

49. (canceled)

50. The second AP of claim 41, wherein the controller is further configured to transmit, when the contended TXOP resources are won, an indication that the TXOP is shared.

51.-52. (canceled)
